(19) United States
(12) Patent Application Publication
(10) Pub. No.: US 2003/0078050 A1
(43) Pub. Date: Apr. 24, 2003

(54) Method and apparatus for allocating air interface resources

(76) Inventors: Paul Carlborg, Crystal Lake, IL (US); Michael J. Bach, Kildeer, IL (US)

Correspondence Address: VEDDER PRICE KAUFMAN & KAMMHOLZ, 222 N. LASALLE STREET, CHICAGO, IL, 60601, US

(21) Appl. No.: 10/001,380

(22) Filed: Oct. 24, 2001

(51) Int. Cl. H04Q 7/20

(52) U.S. Cl. 455/452; 455/450; 455/417

(57) ABSTRACT

A wireless communication system employs a wireless network element (104) and at least one remote wireless unit (102) that employ an air interface resource reservation and negotiation scheme. In one embodiment, the remote wireless unit (102) includes a processing device (106) operatively coupled to a radio frequency transceiver (108), that outputs an air interface reservation resource request (122). The air interface reservation resource request (122) includes one or more air interface resource reservation parameters (115). The air interface resource reservation parameters (115) are used to define a future time that is reserved by the wireless network element (104) for the remote wireless unit (102) so that suitable air interface resources are available at a defined future time. In one example, the air interface resource reservation parameters (115) include a position of a communication unit (502), a date and time of day (506), a desired bit rate for the defined future time (504), desired quality of service data (508), priority data associated with a plurality of air interface resource reservation parameters, and user identification data (500).

### FIELD OF THE INVENTION

The invention relates generally to wireless communication systems, and more particularly to wireless communication systems and methods that allocate air interface resources in response to a user request.

### BACKGROUND OF THE INVENTION

Wireless communication systems, such as radiotelephone communication systems (including microwave wireless systems), or other communication systems, require that wireless base stations or other infrastructure elements allocate appropriate air interface resources, such as time slots, frequencies, Walsh codes, transceivers, antennas, or any other resources necessary to properly communicate information over a wireless link. In conventional wireless systems, if base station resources or other air interface resources are not available for a user, such as a remote unit, including, but not limited to, a mobile telephone, information appliance, software application or any other user of the wireless communication link, the base station typically provides a busy signal. Accordingly, a user is not able to determine a suitable time at which to attempt origination, nor are methods available to allow a user to schedule the resources at some user defined future time.

Furthermore, a user is also not typically aware of current conditions of a wireless system and is therefore unable to make determinations as to whether to originate a service and possibly overload the system and/or be given a lesser rate than desired, or to postpone communication until a more appropriate time.

In Standard IS-95B, CDMA, a code division multiple access wireless communication system can use a control channel to tell the user where they are in a queue. This can extend the call set up time until a user reaches the end of a queue. The system can also instruct a mobile unit to re-originate or cancel a call using a PACA message. However, there is typically no indication to the user that they may run out of bandwidth or may be disconnected during transmission due to lack of air interface resources or signal quality. It would be desirable to better guarantee access to an air communication link or traffic channels so that a user is certain that the information will be sent at a desired rate and in a manner desired, e.g., at a user specified minimum rate, even if the user must wait for a later time to transmit or receive. For example, many users, may be software applications that need to send large amounts of data which can be sent at non-peak times. The contention for bandwidth may increase as higher rate data users seek access. Also, customers buying expensive, high rate enabled devices may want high speed access which current systems do not guarantee. In addition, users have no way to reserve the air interface resources beforehand for known busy times.

Accordingly, there exists a need for a wireless communication system and method that facilitates the reservation of bandwidth at defined future times.

### BRIEF DESCRIPTION OF THE DRAWINGS

FIG. 1 is a block diagram illustrating one example of a wireless communication system employing an air interface resource reservation processor and a remote unit in accordance with one embodiment of the invention.

FIG. 2 is a block diagram illustrating one example of an air interface resource reservation processor incorporated as part of a CDMA radiotelephone communication system in accordance with one embodiment of the invention.

FIG. 3 is a flow chart illustrating one example of the operation of an air interface resource reservation processor in accordance with one embodiment of the invention.

FIG. 4 is a flow chart illustrating one example of the operation of a wireless network element in accordance with one embodiment of the invention.

FIG. 5 is a diagram illustrating air interface resource reservation parameters in accordance with one embodiment of the invention.

### DETAILED DESCRIPTION OF THE PREFERRED EMBODIMENTS

A wireless communication system employs a wireless network element and at least one remote wireless unit that employ an air interface resource reservation and negotiation scheme. In one embodiment, the remote wireless unit includes a processing device operatively coupled to a radio frequency transceiver, that outputs an air interface reservation resource request. The air interface reservation resource request includes one or more air interface resource reservation parameters. The air interface resource reservation parameters are used to define a future time that is reserved by the wireless network element for the remote wireless unit so that suitable air interface resources are available at a defined future time. The defined future time may be defined by a user or by a network element. In one example, the air interface resource reservation parameters include a position of a communication unit, a time of day, including date, a desired bit rate for the defined future time, desired quality of service data, priority data associated with a plurality of air interface resource reservation parameters, and user identification data.

The wireless network element receives the air interface resource reservation request to determine whether an air interface resource is available for the user at a defined future time and generates an air interface resource reservation response for the remote wireless unit, indicating whether the desired resource will be available for the remote wireless unit.

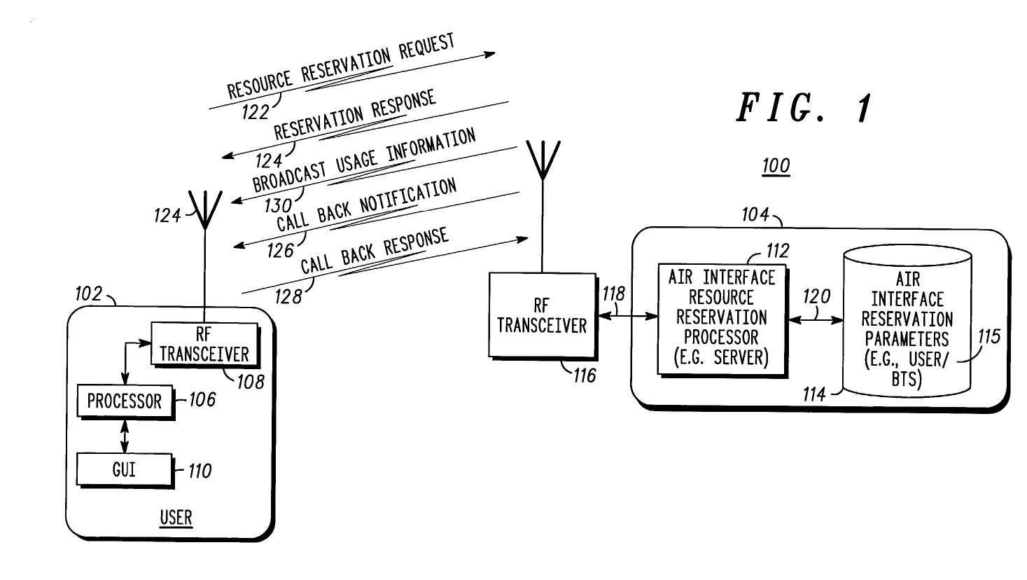

FIG. 1 illustrates one example of a wireless communication system 100 having a remote wireless unit 102 and a wireless network element 104. For purposes of illustration, and not limitation, the invention will be described with reference to a CDMA wireless radiotelephone communication system. However, it will be recognized that any suitable communication system may benefit from the herein described invention, including but not limited to ones based on infrared, microwave, millimeterwave or any other suitable frequency spectrum. The remote wireless unit 102 may include a processing device 106, a radio frequency transceiver 108, and may be any suitable mobile or nonmobile remote wireless unit. For example, the remote wireless unit 102 may be a laptop computer, handheld information appliance that may interface with the Internet, a radiotelephone, or any other suitable unit. The remote wireless unit 102 may serve as a user of air interface resources. In addition, a user of air interface resources may include one or more software applications operating on the remote wireless unit, such as an e-mail application, Web browser, or any other suitable software application. As used herein, the word “data” includes any data such as voice information, video information, audio information, digital non-voice information and non-audio information. The wireless communication system 100 may be part of a wireless CDMA communication system such as an IS-95B CDMA compliant system, as known in the art, or any other suitable communication system. The remote wireless unit 102 also provides a graphic user interface (GUI) 110. However, any other suitable interface, such as a voice-activated interface, key character entry pad, may be used. In addition, no operator interface may be necessary if the user (e.g., software applications, devices or other entity) automatically determines future times to reserve and automatically negotiates with the system based on a set of known criteria. The processing device 106 is operatively coupled to communicate with the transceiver 108 and provides any graphic user interface 110 on a suitable display device and also receives information input from an operator through the graphic user interface 110, as known in the art.

The wireless network element 104, in this example, includes an air interface resource reservation processor 112 and memory 114. The wireless network element 104 may be part of a radiotelephone base station controller (BSC), mobile switching center (MSC), or any other suitable wireless network element. In addition, it will be recognized that the air interface resource reservation processor 112 may be a stand alone processor, a network server, or may be suitably incorporated in any other unit within a wireless network element. The air interface resource reservation processor 112, in this embodiment, may be a suitably programmed microprocessor which is operatively coupled to a radio frequency transceiver 116 through a suitable link 118. The air interface resource reservation processor 112 is also operatively coupled to memory 114 through a suitable link 120. The memory 114 may be, for example, a remote or onsite database, or any other suitable memory element. The air interface reservation processor 112 preferably stores, on a per remote unit basis, or per software application basis, and on a per basesite transceiver station (BTS) basis, the air interface resource reservation parameters 115 in memory 114. The radio frequency transceiver 116 may be one or more basesite transceiver stations (BTS), or any other suitable transceiver.

The remote wireless unit 102 generates an air interface reservation resource request 122 which contains one or more air interface resource reservation parameters used to reserve one or more air interface resources for the remote wireless unit at a defined future time. The remote wireless unit 102 sends the air interface resource reservation request 122 on a suitable access channel, or any other suitable channel, if desired. The processing device 106 outputs the air interface resource reservation parameters associated with the remote wireless unit to the radio frequency transceiver 108 for transmission over a suitable antenna 124 in the form, for example, of the air interface reservation resource request 122. The air interface reservation resource request 122 is transmitted to reserve the desired bandwidth (e.g., bit rate) required for one or more software applications on the remote wireless unit according to the air interface resource reservation parameters. Accordingly, a user can reserve the necessary bit rate rather than be given a lower bit rate due to congestion.

For example, an operator of the remote wireless unit 102 may decide that large amounts of non-voice or non-audio files need to be communicated at a later point in time and that, at the same time, a voice transmission (e.g., telephone call) is also required. Accordingly, a desired bandwidth, such as bit rates for communication of the non-voice information as well as the voice information needs to be reserved by the remote wireless unit 102. By way of example and not limitation, air interface resource reservation parameters that may be sent as part of the air interface reservation resource request 122 include a position of the remote wireless unit at the future time, such as global positioning coordinates, a time of day when the remote wireless unit requires the dedicated reserved bandwidth, a date indicating a day and year for that time, a desired bit rate (perhaps aggregate) for the defined future time, a time length for the call or a maximum number of bits to be sent, a desired quality of service, priority data associated with a plurality of air interface resource reservation parameters, and user identification data. For example, a desired quality of service may be indicated by desired quality of service data which indicates an acceptable bit error rate (BER), or frame error rate (FER) and/or maximum delay that the remote wireless unit 102 is willing to accept during transmission. Any other suitable desired quality of service criteria may also be used. Priority data associated with the plurality of air interface resource reservation parameters may include, for example, one or more data bits indicating which of the air interface resource reservation parameters receives priority in a re-negotiation in the event of a conflict.

For example, the total bit rate may have a higher priority than the time of day that the user desires the information to be sent. For example, with large data files, the air interface resource reservation processor 112 may determine that the time of day requested is not as suitable as, for example, a future time of day during which larger files may be sent. Accordingly, the total bit rate will take priority and the time of day may be negotiated between the air interface resource reservation processor 112 and the remote wireless unit 102. On the other hand, if the operator is driving in a new city and wishes to hear about local restaurants via an Internet service, the user may only be willing to wait a maximum of one hour, beyond which the operator is not interested in making this particular call, meaning time is a higher priority.

The processing device 106 provides an operator with the GUI 110 so that the operator may select the suitable air interface resource reservation parameters, as desired. Alternatively, the processing device 106 may set default bit rates for certain applications. For example, a default bit rate may be set for voice communication and a different default bit rate may be set for Internet access based data transfer applications, as well as default values of other air interface resource reservation parameters.

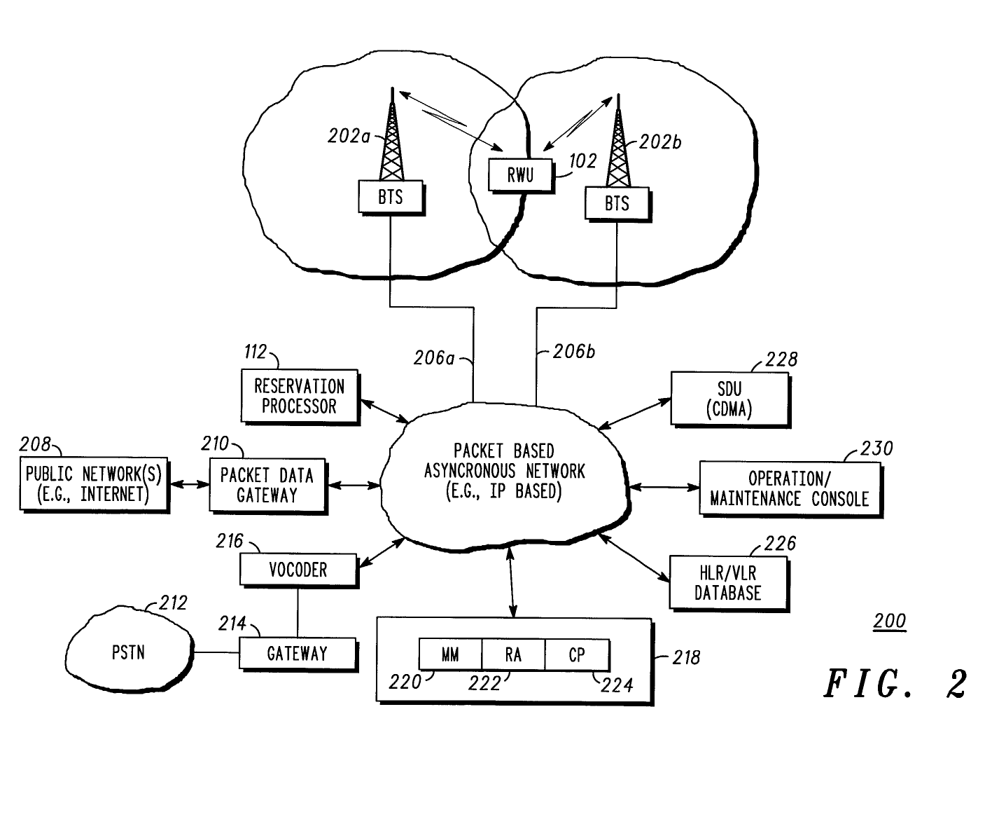

Once the remote wireless unit 102 communicates the air interface reservation resource request 122, and the wireless network element 104 receives the air interface reservation resource request 122, the air interface resource reservation processor 112 evaluates the air interface resource reservation parameters associated with the user to determine whether a desired bandwidth, such as a bit rate, is available for the user at a defined future time. The air interface resource reservation processor 112 subsequently generates an air interface resource reservation response 124 to the RF transceiver 116 for communication back to the remote wireless unit 104, in response to the evaluated received air interface resource reservation parameters. The air interface resource reservation response 124 may be in any suitable format and communicated over an overhead channel or any suitable channel as desired. As another example, the air interface reservation resource request 122 and the air interface resource reservation response 124 may be communicated on a different system such as a narrow band (e.g., pager on a paging system) system to reserve bandwidth on a wideband cellular system of FIG. 2. The air interface resource reservation response 124 includes confirmation data indicating whether the desired bandwidth will be available for the remote wireless unit 102 at the defined future time, as defined by the time of day information sent with the air interface reservation resource request 122 and if not, can include alternative parameters to propose optional parameters to facilitate negotiation to determine alternative air interface resource requirements. The duration of a call may be specified as a resource reservation parameter. The duration of a call may be set to a default duration by the resource reservation processor 112 based on statistical data. For example, it may be determined that a voice call typically lasts for one minute. Therefore the duration of a call may be set at one minute as a default value. The alternative parameters are generated based on demands for air interface resources as determined by the air interface resource reservation processor 112 and priority data (if any) from the air interface resource reservation request 122.

Also, if desired, the air interface resource reservation processor 112 may generate a call back notification for the remote wireless unit 102, notifying the remote wireless unit 102 that a reserved time is soon to come or that it is now time to originate a call. For example, the call back notification 126 may be sent at some time prior to the actual call initiation by the remote wireless unit 102 to notify the remote wireless unit 102 that the reserved time is, for example, five minutes away, or one minute away, or any other suitable time. In this way, if the remote wireless unit 102 no longer needs the information, the wireless network element 104 may allocate those resources to another remote wireless unit. Accordingly, the processing device 106 evaluates the call back notification 126 and begins call initiation at the appropriate time, based on the call back notification. Alternatively, the processing device 106 may determine that the previously reserved air interface resources are no longer needed and communicates a call back response 128 notifying the wireless network element 104 to suitably change the air interface reservation requirements accordingly. In addition, the call back response 128 can be used by the reservation processor 112 to determine a location of the unit just before the time of the call, and free up other cells outside the destination cell that have been reserved as part of a larger location area (group of cells).

Also, if desired, the air interface resource reservation processor 112 may broadcast air interface resource usage information 130 that is transmitted by the RF transceiver 116 over a broadcast channel. For example, the RF transceiver 116 may broadcast air interface resource usage information 130 such as cell overhead information to all users in a cell over a broadcast channel indicating to an operator, for example, that the cell is 90% full on all available carriers so the operator will know that transmission quality may be low on a dedicated channel at a given point in time. For example, an RF transceiver, such as a BTS, keeps track of current air interface resources that are allocated at a given point in time and broadcasts its capacity on a broadcast channel. The operator may then suitably select air interface resource parameters accordingly. This may then allow the operator to suitably select different air interface reservation parameters to, for example, select a different application to begin transmission during a lower quality level if, for example, low transmission quality can be tolerated. For example, a video call may be postponed in favor of a voice data transmission based on the interface resource usage information 130, or the operator may decide to wait altogether and requests a reservation for a time in the future. The air interface resource usage information 130 may include surrounding cell usage data, current loading on a cell broadcasting the air interface resource usage information and an estimated time to wait for desired air interface resources, or any other suitable data. In addition, the broadcast air interface usage information when displayed for an operator, can provide useful information as to whether the operator should move into another cell if the capacity of a new cell is largely used.

Where the RF transceiver 116 provides air interface resource usage information 130, the remote wireless unit 102 may display received air interface resource usage information 130 on the graphic user interface 110 for display, or in another appropriate manner (e.g., audio output). This allows an operator to evaluate whether, for example, congestion may be an issue in view of the air interface usage information 130.

If desired, the processing device 106 may provide the defined future time for transferring information, as an air interface resource reservation parameter. If desired, the air interface resource reservation processor 112 can also determine the future time since it may have to change based on limitations of the communication system. For example, the time requested by a user may not be available if other users have already requested all bandwidth up to an appropriate threshold level available for the particular cell at a particular time. Accordingly, the air interface resource reservation processor 112 can determine the defined time as opposed to the defined time being selected by an operator or determined by the processing device 106.

FIG. 2 illustrates one example of a CDMA wireless communication system 200 that includes a plurality of basesite transceiver stations (BTS's) 202a and 202b, that operatively communicate with a packet based asynchronous transmission network 204 through suitable communication links 206a, 20b, such as T1 lines, or any other suitable communication links, as known in the art. The CDMA wireless communication system 200 may further include one or more public networks, such as the Internet 208, which interfaces with the packet based asynchronous transmission network 204 through a packet data gateway 210, as known in the art. Additionally, public switching telephone network 212 may communicate with the remote wireless unit 102 through MSC gateway 214 and vocoder 216. The CDMA wireless communication system 200 may also include a basesite controller (BSC) 218, which includes a mobility management module 220, a resource allocation module 222 and a call processing module 224, as known in the art. A home location register and visitor location register database 226 serves to facilitate mobility tracking and includes user profiles for users roaming among various cells, as known in the art. The CDMA wireless communication system 200 may also include a selective distribution unit 228 which may distribute data to multiple BTSs, and an operations and maintenance console that serves as a user interface 230. The mobility management module 220 manages a handover, as known in the art, while the resource allocation module 222 allocates air interface resources, e.g., transceivers to provide suitable frequencies, time slots, Walsh codes, vocoders for voice calls through the PSTN, or other air interface resources. The call processing module 224 facilitates paging, releasing of calls and control of protocol, as known in the art. Although a small system is shown, it will be recognized, however, that a larger distributive architecture is often desirable. Packets of information communicated through the packet based asynchronous transmission network 204 may be bursty in nature and may have varying degrees of delay tolerance. For example, bit rates of 384 kilobits per second may be desirable. Such high bit rate applications are typically asynchronous in nature. As known in the art, high speed packet data communication typically involves more channel resource allocations due to their asynchronous and bursty nature.

In operation, the air interface resource reservation processor 112 controls arbitration of air interface usage using a suitable reservation policy. Accordingly, the remote wireless unit 102 provides the data rate for an end connection and the approximate session start time, whereupon the data should be transferred. This is done by sending the air interface reservation resource request 122 that includes the air interface resource reservation parameters. If the air interface resource reservation processor 112 cannot meet the requirements as set forth by the reservation parameters, the user may choose to wait, abort the transfer or set up a transfer at a later time. At the defined prescribed time, the BSC 218 preferably calls the remote wireless unit 102 back and sets up the call. In this embodiment, an air interface resource includes a code division multiple access air interface resource, such as a spreading code and associated traffic channel and a bit rate. While the reservation process described herein refers to a remote wireless unit, it will be recognized that such a process could be applied to the landline side of the system to provide the ability to reserve mobile terminations.

The air interface resource reservation processor 112 is shown in this embodiment as a server. There also can be an extension of the multiple access control (MAC), resource allocation (RA) functions on the part of the resource allocation block 222 and BSC 218 which may allow further control and time access, particularly for high rate supplemental channel access for a system such as that described in TR45 CDMA 2000 Standards of Spread Spectrum Systems PN-4427, available from EIA/IS-2000 at www.cdma2000fg.com, and incorporated herein by reference.

If desired, to schedule a guaranteed service for a specified future time period, prepayment or a system debiting of an operator's account may be desirable before a reservation is granted. In addition, if desired, a plurality of reservation processors 112 may communicate to exchange information and reservations as desired. A user may negotiate an asynchronous video service, for example, in a location where the data transfer is to take place using a narrowband paging system, and the system 200 reserves bandwidth in the specified BTS for such use. Reservations may also be made on a re-occurring basis such as weekly at the appointed time and place.

Where the RF transceiver 116 as part of a BTS 202 broadcasts air interface resource usage information, the defined time for bandwidth usage in the future is based on the capacity of the relevant BTS to determine a best time for which to reserve bandwidth for the future. The air interface resource usage information may include, for example, surrounding cell usage information as obtained from neighboring BTS'. The air interface resource usage information may be communicated on a common channel.

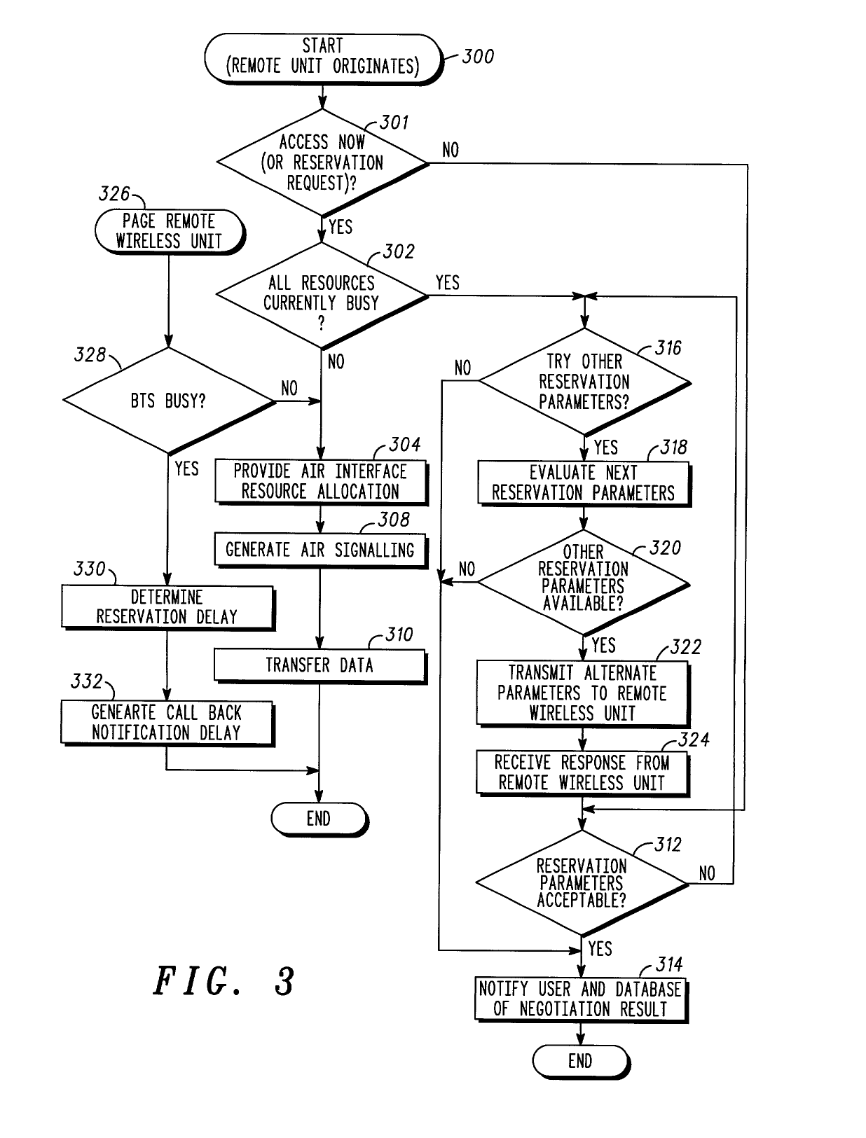

FIG. 3 illustrates one example of the operation of the air interface resource reservation processor 112. As shown in 300, the remote wireless unit 102 originates communication. The remote wireless unit 102 may know apriori that negotiation for air interface resources is required if, for example, the air interface resource reservation processor 112 or BTS 202 communicates that all available bandwidth is already is use, via the broadcast air interface usage information 130. As shown in block 301, the BTS determines if the origination is a conventional access request or if the remote wireless unit 102 is generating an air interface resource reservation request 122. This may be done based on a reservation request indication bit or in any other suitable manner. If the origination is requesting access to the air interface resource (e.g., a traffic channel) immediately and not at a future time, the process continues to block 302 where the BSC 218 determines if all air interface resources are being used. If not, the resource allocation module 222 allocates the suitable air interface resources that facilitate wireless communication with the wireless remote unit 102 as shown in block 304. This includes conventional air interface resource allocation as known in the art. The process continues in a conventional manner, as shown in blocks 308 and 310 to set up communication and provide suitable signaling from a BSC 218 and provide data transfer after a proper communication call set up.

However, if the origination includes an air interface reservation resource request 122, the process includes evaluating the received air interface resource reservation parameters 115 associated with the air interface reservation resource request 122 to determine whether desired bandwidth, such as a bit rate, of an air interface resource is available for the user at a defined future time, as shown in block 312. This is done by comparing the air interface resource reservation parameters 115 that have been received (and stored) from the remote wireless unit to parameter limits stored in memory 114 by the air interface resource reservation processor 112. For example, if the overall capacity of a carrier or carriers associated with a BTS 202 has already been reduced so that a particular traffic channel is limited or set to a maximum bit rate due to other reservation requests or current usage, the received air interface reservation bit rate indication, for example, may exceed the set limit and accordingly the reservation request will be denied. If the received air interface resource reservation parameter or parameters are acceptable, the process continues to block 314 which includes notifying the user and storing the acceptable air interface resource reservation parameters in memory 114. The notification is carried out by generating an air interface resource reservation response 124 for the user, which acts as a confirmation.

Referring back to block 312, if the received air interface resource reservation parameters are not acceptable, the process may include negotiating with the remote wireless unit 102 to obtain another suitable future time for later communication. As shown in block 316, a check is made whether to negotiate further. If so, the reservation processor 112 searches the stored reservation parameters 115 to determine whether other times are available that may meet the received air interface resource reservation parameter that was not acceptable by evaluating the stored resource reservation parameters. For instance, the reservation processor 112 finds the nearest time that is available, as shown in block 318. One of the reservation parameters may be priority data which indicates a ranking of the other parameters for deciding their relative importance in arbitrating new parameter values. Alternatively, preferred parameter values (e.g., 7:30 vs. 7:00 p.m.) may be sent by the user. The process includes determining whether other resource reservation parameters, such as other future times, bit rates and other parameters, are available, as shown in block 320. If other parameters are available, the reservation processor notifies the suitable BTS to signal the remote wireless unit with the alternate parameters, as shown in block 322. In block 324, the remote wireless unit then evaluates the alternate parameters to determine whether they are acceptable. For example, the alternative parameters may be displayed for an operator, and the operator may select whether these alternatives are acceptable. A response is then returned to the reservation processor 112. This reservation negotiation process may be repeated one or more times.

If desired, the reservation processor 112 may facilitate call back notification for a user near the appointed reservation time indicating, for example, that the reservation has to be delayed due to busy condition, or other notification indicating that the call will take place in a short period of time, or determining whether a cell where the user is located is busy and freeing up a parameter reservation for the user in another cell, notifying the user to originate, indicating a delay, renegotiating air interface reservation parameters, or any other suitable process. For example, as shown in block 326, the method includes paging the remote wireless unit on the paging channels of various carriers. This can locate the remote unit. The process includes determining whether the would-be serving BTS is busy at the time of the desired call, or at a point suitably before the designated time, as shown in block 328. The reservation parameters might then be cleared from the stored database (114). If the serving BTS is busy, the process includes determining the amount of delay required to have enough bandwidth to complete the communication, as shown in block 330. As shown in block 332, the method includes generating a callback notification 126 for the user, notifying the user of the amount of delay. This may include, for example, providing a new time for which the user must call back. This new time would be reserved. The user then acknowledges receipt of the message, indicating acceptance. Alternately, nonacceptance means the reservation would be cleared and the failure recorded. For instance, the user may be given a rebate on their bill for reservation failures. Referring back to block 328, if the BTS is not busy, the process proceeds to block 304, where the air interface resources are allocated.

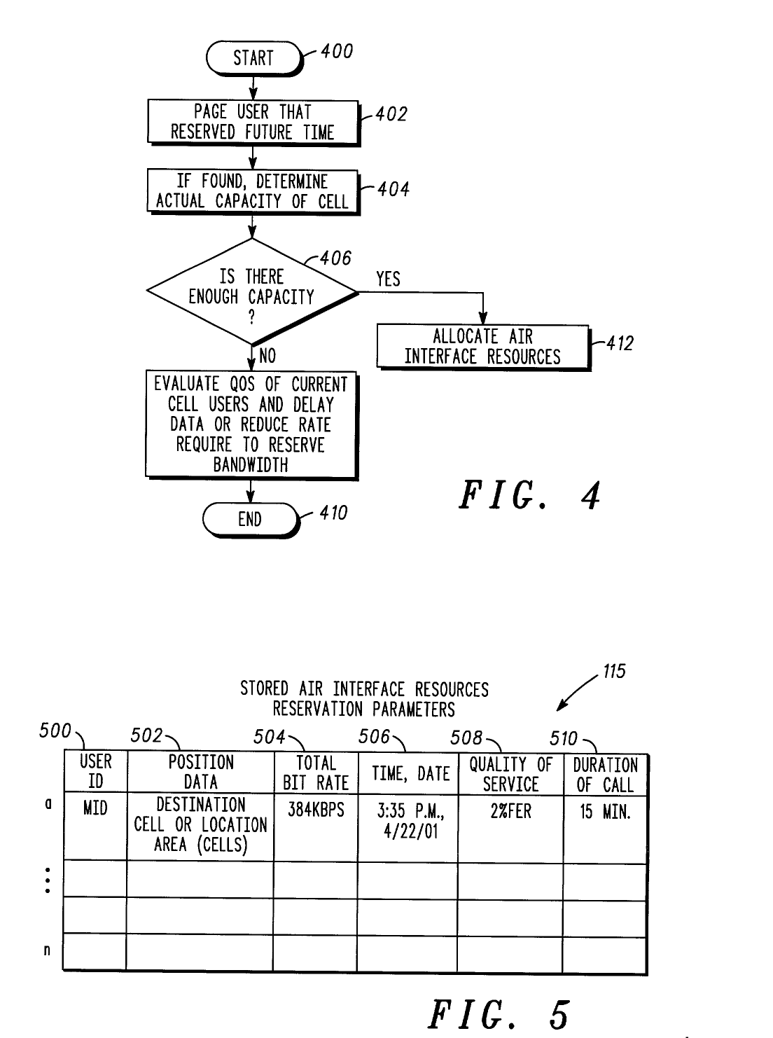

FIG. 4 is a flow chart indicating one example of wireless remote unit location verification that may take place prior to the final actual allocation of resources once resources are initially reserved. This may find use, for example, in CDMA systems wherein the mobility of a user may greatly impact the demands on the systems since power levels may be lower or higher as users are moving throughout the system and it may be difficult to determine the exact number of users a cell can support ahead of time. The current capacity of the cell depends on the current location of active users. Thus, getting location information is useful in fine tuning the process. As shown in block 400, the process begins by determining a user near in time, for example, to the reserved time by evaluating the time of day data. For mobile systems where user location is not fixed, as shown in block 402, the method includes paging the user that reserved the future time to determine their current location and thus know which destination cell air interface resources they will need. If the user had reserved a particular cell as one of their parameters, this may not be necessary. As shown in block 404, the process includes determining the actual capacity of the destination cell if the user is found. The resource reservation processor 112 request the capacity information from the RF transceiver to determine current loading. The paging of the user should preferably occur within a short time before the designated reserved time, such as prior to the actual reserved time, in order to accurately determine the capacity of the cell.

As shown block 406, the process includes determining whether there is enough capacity in the cell. As shown in block 408, if there is not enough capacity in the cell for the reserved bandwidth, the reservation processor evaluates the quality of service parameters of current cell users and delays the data transfer or reduces the data rate of other users, as required to free the desired bandwidth. The user is then notified as shown in block 410. If there is enough capacity, the reservation processor notifies the BTS to allocate the air resources to set up the call, as shown in block 412.

FIG. 5 shows one example of stored air interface resource reservation parameters 115. In this example, a database is maintained which stores users identification data 500, position data of the communication unit associated with the user at the destination cell or cells (location area) to be reserved 502, the desired bit rate 504 at a future time, the reservation time and date, desired quality of service data 508, duration of call 510 and other data, such as priority data associated with the reservation parameters 115. By way of example, the user identification data 500 may be a mobile identification number, IP address, etc. or any other suitable information. The destination position data 502 may be the destination cell name or cell number or a location area (group of cells) where the remote wireless unit is to be located at the time of the reserved call. A location area includes a plurality of cells larger than one destination cell in the event the eventual position data 502 is uncertain at the time the reservation is made. The desired bit rate for the defined future time 504 may be set in terms of kilobits per second, megabits per second, or any other suitable information rate. It will be recognized that this information may be different for differing applications for the same wireless remote unit. The desired quality of service data 508 indicates, for example, an amount of acceptable bit error rate or frame error rate for each application. Priority data might indicate which of the parameters take precedence in the event of the need to renegotiate.

In addition, to facilitate alternative parameter choices for a remote wireless unit, the reservation processor 112 may obtain or keep statistics on a per cell basis to determine actual and typical channel utilization per day per time period. These statistics may already be available to aid in allocating new calls, rate requests and for handovers. This information can be used to recommend to a user a time to call to achieve a certain bit rate or gain entrance to the system. This information can be sent via a broadcast air interface resource usage data. For example, the highest data rates may only be available late at night and/or at certain locations. Moreover, the remote wireless unit can use its internal clock to power up at the appointed defined time that the communication has been scheduled to save battery life. In addition, the cost structure for a given user can vary, with high cost during known busy times. Accordingly, as part of the negotiation process, the reservation processor may assign the user bandwidth at a later date. One advantage is that the system operator may be able to generate additional revenue during non-peak times. The user may also benefit since rates during off-peak times are typically less expensive compared to peak times. Also, the reservation processor may be consulted to determine the best times to push or pull information during the day.

Accordingly, the disclosed reservation processor indicates an estimated time until service availability can occur and/or indicates other cells where service is available and negotiates and schedules an agreed future call time to enable more efficient operation of a wireless system via a Resource Reservation Request and Response. Current usage statistics are broadcast continuously via a broadcast air interface resource usage information 130 to allow an operator to determine whether alterations should be made to facilitate completion of data transfer due to changing conditions. The disclosed system and methods allow the reservation of and allocation of air interface resources in advance of the call as opposed to a first come first served scheme.

It should be understood that the implementation of other variations and modifications of the invention in its various aspects will be apparent to those of ordinary skill in the art, and that the invention is not limited by the specific embodiments described. It is therefore contemplated to cover by the present invention, any and all modifications, variations, or equivalents that fall within the spirit and scope of the basic underlying principles disclosed and claimed herein.

What is claimed is:

1. A method for allocating air interface resources for a user in a wireless communication system comprising the steps of:
evaluating at least one received air interface resource reservation parameter associated with the user, to determine whether a bandwidth of an air interface resource is available for the user at a defined future time; and
generating an air interface resource reservation response for the user in response to the evaluated received air interface resource reservation parameter.

2. The method of claim 1 wherein the air interface resource reservation parameter includes at least one of: a position of a communication unit associated with the user, a time of day, a date, a desired bit rate for the defined future time, desired quality of service data, duration of a call, priority data associated with a plurality of air interface resource reservation parameters, and user identification data.

3. The method of claim 1 including the step of receiving an air interface reservation resource request to reserve the bandwidth.

4. The method of claim 1 including the step of negotiating with the user to determine alternative air interface resource requirements based on demands for air interface resources.

5. The method of claim 1 wherein the air interface resource reservation response includes confirmation data indicating that the bandwidth will be available for the user at the defined future time.

6. The method of claim 1 wherein the air interface resource includes a code division multiple access (CDMA) air interface resource.

7. The method of claim 1 including the step of broadcasting air interface resource usage information for a plurality of users to facilitate selection of at least one air interface resource reservation parameter.

8. The method of claim 1 including the step of determining the defined time based on the air interface resource reservation parameter and based on air interface resource usage data.

9. The method of claim 7 wherein the air interface resource usage information includes at least one of: surrounding cell usage data, current loading on a cell broadcasting the air interface resource usage information and an estimated time to wait for desired air interface resources.

10. The method of claim 1 including the step of generating a call back notification for a user to perform at least one of: locating the user as an agreed reservation time approaches; determining whether a cell where the user is located is busy and freeing up a parameter reservation for the user in another cell; notifying the user to originate; indicating a delay; and renegotiating air interface reservation parameters.

11. A method for allocating air interface resources for a user in a wireless communication system comprising the steps of:
generating an air interface resource reservation parameter associated with the user, for use in determining whether a bandwidth of an air interface resource is available for the user at a defined future time; and
evaluating an air interface resource reservation response that was generated in response to the air interface resource reservation parameter, to determine availability of the bandwidth.

12. The method of claim 11 wherein the air interface resource reservation parameter includes at least one of: a position of a communication unit associated with the user, a time of day, a date, a desired bit rate for the defined future time, desired quality of service data, priority data associated with a plurality of air interface resource reservation parameters, and user identification data.

13. The method of claim 11 including the step of generating an air interface reservation resource request to reserve the bandwidth.

14. The method of claim 11 including the step of negotiating to determine alternative air interface resource requirements based on demands for air interface resources.

15. The method of claim 11 wherein the air interface resource reservation response includes confirmation data indicating that the bandwidth will be available for the user at the defined future time.

16. The method of claim 11 wherein the air interface resource includes a code division multiple access (CDMA) air interface resource.

17. The method of claim 11 including the steps of:
broadcasting air interface resource usage information for a plurality of users to facilitate selection of at least one air interface resource reservation parameter; and
receiving air interface resource usage information.

18. The method of claim 11 including the step of transmitting the desired time as an air interface resource reservation parameter.

19. The method of claim 17 wherein the air interface resource usage information includes at least one of: surrounding cell usage data, current loading on a cell broadcasting the air interface resource usage information and an estimated time to wait for desired air interface resources.

20. A wireless network element comprising:
a radio frequency (RF) transceiver operatively coupled to receive an air interface resource reservation request; and
an air interface resource reservation processor operatively coupled to the radio frequency transceiver and operatively responsive to the air interface resource reservation request, to evaluate at least one received air interface resource reservation parameter associated with the user, to determine whether a bandwidth of an air interface resource is available for the user at a defined future time, and operative to generate an air interface resource reservation response to the RF transceiver, in response to the evaluated received air interface resource reservation parameter.

21. The wireless network element of claim 20 wherein the air interface resource reservation parameter includes at least one of: a position of a communication unit associated with the user, a date, a time of day, a desired bit rate for the defined future time, desired quality of service data, priority data associated with a plurality of air interface resource reservation parameters, and user identification data.

22. The wireless network element of claim 20 wherein the transceiver is operatively coupled to receive an air interface reservation resource request to reserve the bandwidth.

23. The wireless network element of claim 20 wherein the air interface resource reservation processor negotiates with the user to determine alternative air interface resource requirements based on demands for air interface resources.

24. The wireless network element of claim 20 wherein the air interface resource reservation response includes confirmation data indicating that the bandwidth will be available for the user at the defined future time.

25. The wireless network element of claim 20 wherein the air interface resource includes a code division multiple access (CDMA) air interface resource.

26. The wireless network element of claim 20 wherein the wireless communication system 200 provides air interface resource usage information for transmission by the RF transceiver.

27. The wireless network element of claim 20 wherein the air interface resource reservation processor determines the defined time based on the air interface resource reservation parameter and based on air interface resource usage data.

28. The wireless network element of claim 26 wherein the air interface resource usage information includes at least one of: surrounding cell usage data, current loading on a cell broadcasting the air interface resource usage information and an estimated time to wait for desired air interface resources.

29. A remote wireless unit comprising:
a radio frequency transceiver,
a processing device operatively coupled to the RF transceiver, and operative to output an air interface resource reservation parameter associated with the remote wireless unit, to determine if a bandwidth of an air interface resource is available for the remote wireless unit at a defined future time, and operative to evaluate an air interface resource reservation response that was generated in response to the air interface resource reservation parameter, to determine availability of the bandwidth.

30. The remote wireless unit of claim 29 wherein the air interface resource reservation parameter includes at least one of: a position of a communication unit associated with the user, a time of day, a date, a desired bit rate for the defined future time, desired quality of service data, priority data associated with a plurality of air interface resource reservation parameters, and user identification data.

31. The remote wireless unit of claim 29 wherein the processing device outputs an air interface reservation resource request, for transmission by the RF transceiver, to reserve the bandwidth.

32. The remote wireless unit of claim 29 wherein the processing device negotiates to determine alternative air interface resource requirements based on demands for air interface resources.

33. The remote wireless unit of claim 29 wherein the RF transceiver receives an air interface resource reservation response that includes confirmation data indicating whether the bandwidth will be available for the remote wireless unit at the defined future time.

34. The remote wireless unit of claim 29 wherein the air interface resource includes a code division multiple access (CDMA) air interface resource.

35. The remote wireless unit of claim 29 wherein the processing device displays received air interface resource usage information.

36. The remote wireless unit of claim 29 wherein the processing device provides the defined time as an air interface resource reservation parameter.

37. The remote wireless unit of claim 35 wherein the air interface resource usage information includes at least one of: surrounding cell usage data, current loading on a cell broadcasting the air interface resource usage information and an estimated time to wait for desired air interface resources.
